(19) United States
(12) Patent Application Publication
(10) Pub. No.: US 2024/0391079 A1
(43) Pub. Date: Nov. 28, 2024

(54) PERSONAL SAFETY DEVICE

(71) Applicant: Michelle Fuhrer, Lake Park, GA (US)

(72) Inventor: Michelle Fuhrer, Lake Park, GA (US)

(21) Appl. No.: 18/790,688

(22) Filed: Jul. 31, 2024

Related U.S. Application Data
(63) Continuation-in-part of application No. 18/629,645, filed on Apr. 8, 2024.
(60) Provisional application No. 63/468,123, filed on May 22, 2023.

(51) Int. Cl. B25F 1/00; B26B 11/00

(52) U.S. Cl. CPC B25F 1/006; B26B 11/008

(57) ABSTRACT

A personal safety tool with multiple security functions including: a knife, a handcuff key, a GPS tracker and a glass breaking tool. The blade, made of a metal alloy, is rotatably disposed on the tool body whereby the blade is rotatable from a closed position in the blade cavity to an open position. In the open position, the blade extends outwardly from the tool housing. The longitudinal recess allows the blade to be fully retained and concealed when in the blade is in the closed position. A handcuff key disposed on a second end of the tool housing. A glass breaking tool extends outwardly from a portion of the tool housing, preferably made of tungsten carbide. A GPS tracking device is located internally in a portion of the tool housing. The GPS tracking device activates with a button disposed in the tool housing.

### CROSS-REFERENCE TO RELATED APPLICATIONS

This application is a Continuation-in-Part of U.S. Non-Provisional Application 18/629,645, filed Apr. 8, 2024, which claims priority to U.S. Provisional Application 63/468,123,filed May 22, 2023, which are hereby incorporated by reference in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present invention relates to the field of an unlocking and cutting device, more specifically for assisting an individual to escape from an abduction or hostage situation by being able to remove bonds or handcuffs.

### 2) Description of Related Art

Each day there are reports about individuals who are abducted from their homes, schools, or place of work. In many cases, the abductor binds the hands of the individual as quickly as possible to prevent them from being able to fight back and/or attempt to escape. There are a large number of commercially available items for assisting an individual during an abduction attempt such as whistles, pepper spray, stun guns and phone apps having panic buttons, for example.

Although useful for their intended purpose, these items are immediately recognizable to abductors, and thus are among the first things an abductor will attempt to defeat when approaching the victim. Moreover, once the victim has been subdued and their hands are bound, these devices are immediately discarded by the abductor thus rendering them useless in any future attempt to escape. On the other hand, once bound and secured, often times abductors pay scant attention to the victim.

Accordingly, it would be beneficial to provide an abduction prevention device that is formed as or embedded within a decorative element so as to shield the true purposes of the device. It would also be beneficial if the device was able to be used by an individual to remove bonds such as ropes, zip ties or handcuffs in order to allow an individual to free their hands and escape.

An abduction prevention device is described below. Although described as including a specific number, shape, size, type or orientation of components, this is for illustrative purposes only. As such, the inventive concepts can include any number of different components each capable of performing any number of different functions. Moreover, each of the components can be provided along the device body at any number of different locations.

The device is intended to be carried in plain view and is designed to look harmless and merely perceived as a decorative item, such as jewelry. However, it is further intended to be easily retrieved and utilized to quickly cut through bounds or unlock a handcuff.

Although there are other competitors who promote tools like pepper sprays and personal alarms, multi-tool gadgets, and GPS trackers, the present invention is a safety tool that can be carried discreetly without drawing attention. It also features the importance of a device that is simple to operate, especially under stress. Multifunctionality offers multiple safety features without the need to carry several devices, thus providing a reliable and comprehensive solution for personal protection.

Based on the foregoing, there is a need in the cutting and unlocking device for an otherwise harmless appearing device to be accessible to a victim to use to free themselves.

### BRIEF SUMMARY OF THE INVENTION

In one embodiment, the abduction prevention device can include a knife and a handcuff key that are formed as part of a main body having a decorative shape that hides the appearance of the knife and key.

As described herein, the main body can be constructed from any number of different materials and can include any number of different shapes and sizes. For example, the figures show a nonlimiting example wherein the main body is constructed in the shape of a decorative key having a loop along the top end. In such an embodiment, the main body can preferably be constructed from metal such as stainless steel and/or can be painted gold or plated with gold or painted/plated silver, so as to appear to be an ordinary piece of fine jewelry. The opening along the top end of the key can function to receive a necklace or bracelet that allows the main body to be worn as necklace or bracelet charm.

Of course, the main body can also include any number of different construction materials, and can include any number of different colors than what is described above. Furthermore, the main body may be adorned with any number of decorative elements such as various markings, logos, pictures, jewels and the like, so as to suit the tastes of a consumer to be worn as a piece of jewelry while disguising and concealing the presence of the knife blade and key.

In an embodiment, the bottom end of the main body can be formed to function as a handcuff key having a central aperture and a protrusion that extends outward generally perpendicular angle to the opening. As is known in the art, commercially available handcuffs are produced to lock and unlock using an industry-standard handcuff key. As such, the handcuff key provided along the main body will include the same shape and dimensions of the industry standard key so as to allow the main body to be used to unlock handcuffs.

Although illustrated as the bottom end of the main body having a fanciful key-shape, this is but one possible implement of the device. To this end, other exemplary embodiments are contemplated wherein the handcuff key is 1) provided along a different part of the main body; 2) hidden within the main body so as to be selectively extended therefrom while remaining attached; or 3) hidden within or along the main body so as to be separated therefrom when used to unlock handcuffs.

In an embodiment, the knife can include an elongated member, or blade, having a sharpened edge and a non-sharpened edge. In various embodiments, the knife can be connected to the main body via a hinge allowing the elongated member to fold into and away from the main body itself. In some embodiments, a nub or indention can be provided along the non-sharpened, dull edge to permit a user to manually transition the blade from the folded position to an unfolded position. The cutting effectiveness of the blade may be enhanced by adding serrations.

In one embodiment, when the knife member is in the resting position, the sharp edge of the blade can be within or alongside the main body such that only the non-sharpened edge is visible. As such, the non-sharpened edge will preferably include a similar color or matching to the main body so as to remain disguised. When the blade is opened, it can transition to a position that is perpendicular to the main body and/or can transition to be serially oriented with the main body and extending outward from the top end.

Such positionings allow a user to grip the main body of the device itself and use the sharpened edge of the blade to cut bonds in any number of different positions while their hands are bound. Although described above as including specific components located at specific positions along the main body, this is for illustrative purposes only. To this end, the knife and key can each be removably or permanently positioned anywhere along or within the main body so as to be accessible to a user for the purposes described herein.

In an embodiment, a cutting/key device for use by an abduction victim to escape restraint comprises a small elongated metal body incorporating a fully recessed folding knife blade. A first end forms a key bow and is attached to a retention structure. A second end with a tubular cross section and an extending bit can fit into a key post of a standard pair of handcuffs. Wherein the elongated metal body comprises a slot forming a longitudinal recess into which folding knife blade fits so as to be fully retained and concealed and the metal body further incorporates visual decorative elements.

In an embodiment, an emergency freeing device to escape restraint comprises a small elongated metal body with a first end and a second end. The first end forms a key bow and includes a folding mechanism adjacent to the key bow. The second end comprises a tubular cross section and an extending bit to fit into a key post of a standard pair of handcuffs. A longitudinal recess in the elongated body receives a knife blade attached to the folding mechanism wherein the knife blade folds to fit flush in the recess to be fully retained and concealed. The elongated metal body further comprises decorative visual elements.

In an embodiment, an escape device to escape restraints comprises a small elongated stainless steel metal body having a first end and a second end. The first end comprises a key bow and a folding mechanism adjacent to the key bow, said folding mechanism attached to a knife blade and permitting up to 180° of rotation by the knife blade when in an open configuration. The second end comprising a tubular cross section and an extending bit to fit into a key post of a standard pair of handcuffs and engage a locking mechanism. A longitudinal recess in the elongated body into which the folded knife blade fits into so as to fit flush with the longitudinal recess to be fully retained and concealed when in a closed configuration, and the elongated metal body further comprises decorative visual elements.

Advantages include:
Benign appearance concealing its true purpose from an abductor.
Attractive in its own right as a decorative item of jewelry.
Ease to access and utilize even if bound or handcuffed
Simple to implement and durable.

The foregoing, and other features and advantages of the invention, will be apparent from the following, more particular description of the preferred embodiments of the invention, the accompanying drawings, and the claims.

The instant invention in one form is directed to a personal safety tool or tool, including: a tool housing, a knife or blade, a handcuff key and additionally, either or both a GPS tracking device and a glass breaking tool.

The tool housing has a length and a width. The tool housing including a first housing portion and a second housing portion secured to the first housing portion. The tool housing includes a longitudinal recess disposed between the first housing portion and the second housing portion for containing a blade when retracted.

The blade, made of a metal alloy, is rotatably disposed on the tool body. The blade is rotatable from a closed position in the blade cavity to an open position. In the open position, the blade extends outwardly from the tool housing. The longitudinal recess allows the blade to be fully retained and concealed when in the blade is in the closed position. A thru-pin is disposed through an opening on a first end of the tool housing and through an opening on a blade end wherein the blade rotates about the thru-pin for deployment and retention of the blade.

A handcuff key disposed on a second end of the tool housing, extending outward from the tool housing.

In the present embodiment, the personal safety tool includes the GPS tracking device and/or the glass breaking tool. The GPS tracking device disposed of internally in a portion of the tool housing. The GPS tracking device activates with a button disposed in the tool housing. The glass breaking tool extends outwardly from a portion of the tool housing. The GPS device is designed specifically for tracking the location of a personal safety device. This GPS device may include various components that work together to accurately determine and monitor the position of the personal safety device. The GPS device is attached to the personal safety device, enabling real-time tracking of the personal safety device's location. The GPS device uses satellite signals to determine the precise location of the personal safety device and may relay this information to a user through a variety of means, such as a mobile application or a web-based platform. The GPS device may also allow for historical tracking data to be stored and accessed, providing a record of the personal safety device's movements over time. This GPS device offers a solution for individuals who frequently misplace their personal safety device, providing a convenient and efficient means of locating the item when it is not immediately visible or accessible.

The GPS device may be integrated into the body of the personal safety device, forming a single, unified object. This integration may be achieved through various methods, such as embedding the GPS device within the personal safety device during the manufacturing process, or attaching the GPS device to the personal safety device post-manufacturing. In other cases, the GPS device may be a separate unit that can be attached to the personal safety device through various means, such as adhesive, clips, or straps. A power source may be rechargeable, allowing for extended use of the GPS device. The GPS device may also include a communication module to transmit the location data to a user. This communication module may utilize various communication protocols, such as Bluetooth, Wi-Fi, or cellular networks, to transmit the data to a user's device, such as a smartphone or computer. The GPS device may include a memory module for storing location data. This memory module may allow for the storage of historical location data, providing a record of the personal safety device's movements over time. The stored data may be accessed by the user at any time, providing valuable information about the personal safety device's usage patterns and locations.

The glass breaking tool comes to a tip for impacting glass, preferably made of tungsten carbide. In the present embodiment, the blade would have a sharpened edge and a non-sharpened edge and would be made of a metal alloy, such as tungsten or preferably steel. As an alternate configuration, the sharpened edge having a serration accentuates cutting ability based on materials to be cut.

To improve wearability and camouflage, embellishments or decorative elements are added for stylization. The decorative element includes gold plating or silver plating or coloring. Additionally, in the present embodiment, the handcuff key connects to a retention structure, which may be in the form of a piece of jewelry, such as a keyring, necklace or bracelet.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is an exploded view of the personal safety tool.

FIG. 2A is a side view of the assembled personal safety tool.

FIG. 2B is a side view of the assembled personal safety tool showing internal geometry.

FIG. 3A is a side view of the assembled personal safety tool.

FIG. 3B is a side view of the assembled personal safety tool showing internal geometry.

Corresponding reference characters indicate corresponding parts throughout the

several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

Embodiments of the invention are discussed below. However, those skilled in the art will readily appreciate that the detailed description given herein is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

The terms personal safety device, safety device, safety tool and personal safety tool may be used interchangeably in this disclosure.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors”. Several nonlimiting examples of connectors include, but are not limited to, flexible strips of interlocking projections with a slider (i.e., zipper), thread-to-connect, twist-to-connect, and push-to-connect type devices, opposing strips of hook and loop material (e.g., Velcro®), attractively-oriented magnetic elements or magnetic and metallic elements, buckles such as side release buckles, clamps, sockets, clips, carabiners, and compression fittings such as T-handle rubber draw latches, hooks, snaps and buttons, for example.

Each connector can be permanently secured to the device via a permanent sealer such as glue, adhesive tape, or stitching, for example. Moreover, the term “permanently secured” shall be used to describe a situation wherein two or more objects are joined together in a manner so as to prevent the same objects from being separated. Several nonlimiting examples of permanent connectors include various adhesives such as glue or resin, hardware such as nuts and bolts, and welds, for example.

Devices or system modules that are in at least general communication with each other need not be in continuous communication with each other, unless expressly specified otherwise. In addition, devices or system modules that are in at least general communication with each other may communicate directly or indirectly through one or more intermediaries.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In an embodiment, the cutting/key device takes the form of a decorative, but distinct key device, it is contemplated that this item will be further embellished to camouflage its utility as a key. An elongated body can include a first end and a second end. The first end, or bow, can provide a grip for manipulating the key and turning the lock mechanism of a pair of handcuffs to unlock the pawl and free the ratchet teeth to open the cuffs. Furthermore, the bow configuration can allow for passing a chain, cable, or wire through and thus secure the cutting/key device to a necklace chain, wire, or cable so as to appear to be part of a necklace around a neck or charm on a bracelet or some other item of jewelry. Further, in some embodiments, it is contemplated that bow will incorporate decorative visual elements.

The second end may include a round tubular cross section. A bit can extend perpendicular from end. The tubular cross section and bit can be sized to fit into a handcuff's key post to engage with the locking mechanism and unlock a pair of handcuffs.

As depicted, the elongated body can further accommodate a knife blade incorporated into a slot in the elongated body and attached to a folding mechanism. The knife blade and elongated body can be mated in such a way so that the knife blade fits snugly into a longitudinal recess secured and fully concealed till needed. In operation, a user can access the fully recessed knife blade to open it for use. In one embodiment the knife blade is a stainless-steel blade between 1½″ and 4″ long.

In an embodiment, the cutting/key device takes the form of a decorative, but distinct key device, it is contemplated that this item will be further embellished to camouflage its utility as a key. As depicted, an elongated body can include a first end and a second end. The first end, or bow, can provide a grip for manipulating the key and turning the lock mechanism of a pair of handcuffs to unlock the pawl and free the ratchet teeth to open the cuffs. Furthermore, the bow configuration can allow for passing a chain, cable, or wire through and thus secure the cutting/key device 200 to a necklace chain, wire, or cable so as to appear to be part of a necklace around a neck or charm on a bracelet or some other item of jewelry. Further, in some embodiments, it is contemplated that bow will incorporate decorative visual elements.

The second end may include a round tubular cross section. A bit can extend perpendicular from end. The tubular cross section and bit can be sized to fit into a handcuff's key post to engage with the locking mechanism and unlock a pair of handcuffs.

As depicted, the elongated body can further accommodate a knife blade that can be incorporated into a slot in the elongated body and attached to a folding mechanism. As depicted, knife blade can be open to 90° extending outward from elongated body and attached to folding mechanism. The slot can form a longitudinal recess into which knife blade fits so as to be fully retained and concealed when in a closed configuration.

In an embodiment, the cutting/key device takes the form of a decorative, but distinct key device, it is contemplated that this item will be further embellished to camouflage its utility as a key. As depicted, an elongated body can include a first end and a second end. The first end, or bow, can provide a grip for manipulating the key and turning the lock mechanism of a pair of handcuffs to unlock the pawl and free the ratchet teeth to open the cuffs. Furthermore, the bow configuration can allow for passing a chain, cable, or wire through and thus secure the cutting/key device to a necklace chain, wire, or cable so as to appear to be part of a necklace around a neck or charm on a bracelet or some other item of jewelry. Further, in some embodiments, it is contemplated that bow will incorporate decorative visual elements.

The second end may include a round tubular cross section. A bit can extend perpendicular from end. The tubular cross section and bit can be sized to fit into a handcuff's key post to engage with the locking mechanism and unlock a pair of handcuffs.

As depicted, the elongated body can further accommodate a knife blade that can be incorporated into a slot in the elongated body and attached to a folding mechanism. As depicted, knife blade can be fully open to 180° extending outward from elongated body and attached to folding mechanism. The slot can form a longitudinal recess into which knife blade fits so as to be retained and concealed when in a closed configuration.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

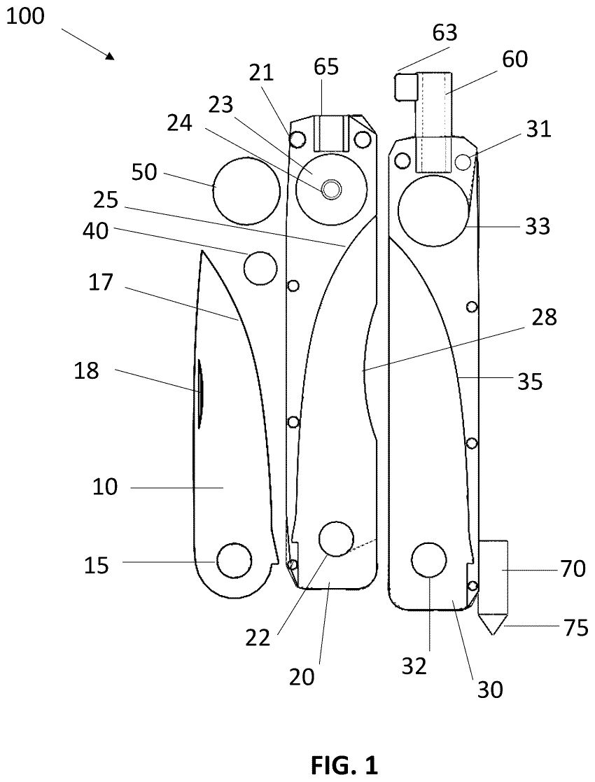

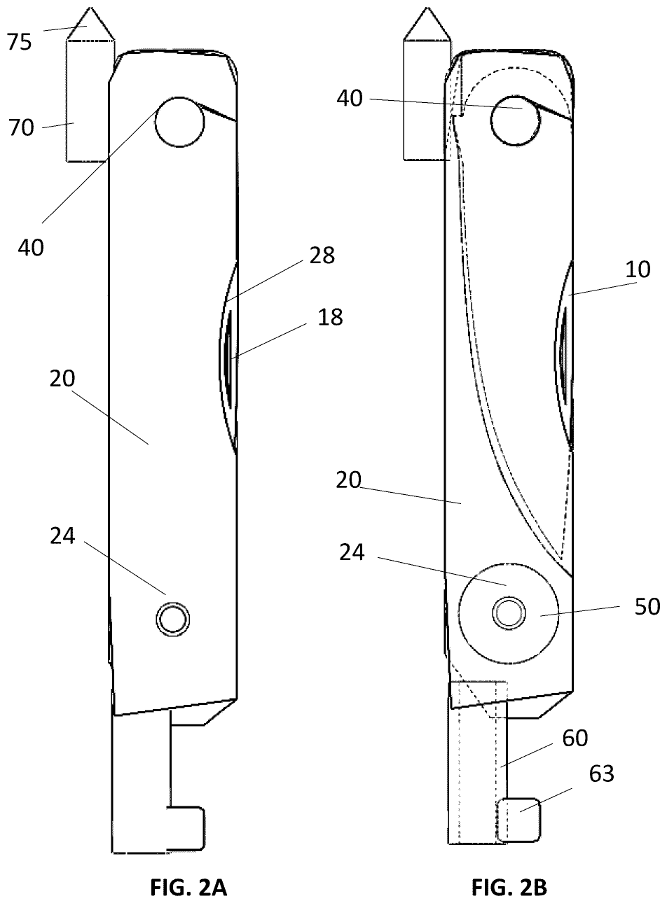

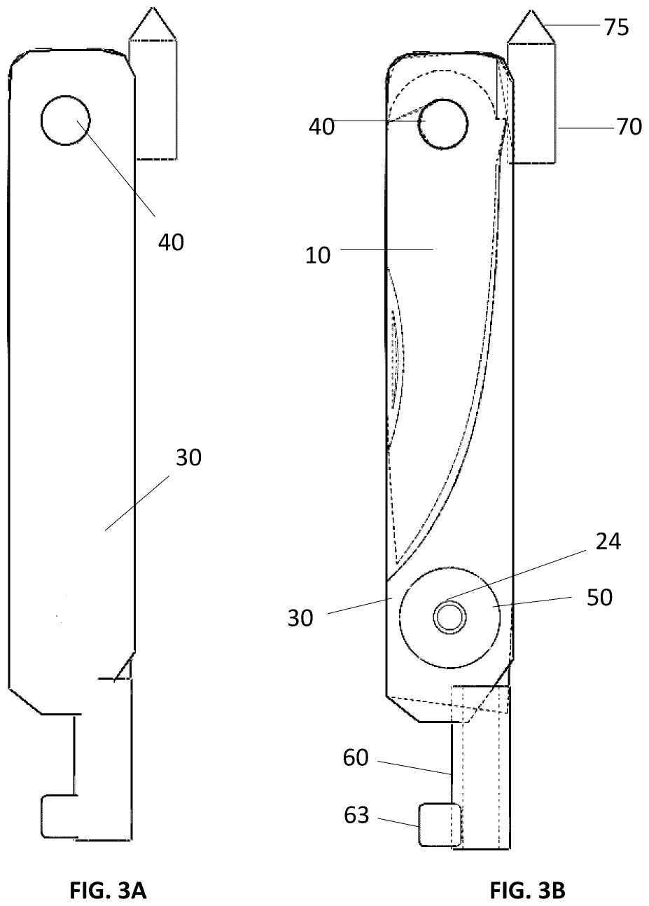

Referring to the drawings FIGS. 1 to 3, specifically in FIG. 1 is shown a personal security tool 100 having a tool housing including a first housing portion 20 and a second housing portion 30. The tool housing includes a first longitudinal recess 25 of the first housing portion 20 and a second longitudinal recess 35 of the second housing portion 30.

A blade 10 is rotatably disposed between the first housing portion 20 and the second housing portion 30 secured in place with a pin 40 aligned in a blade thru-hole 15 to a first thru-hole 22 and a second thru-hole 32. The blade thru-hole 15 is sized for rotation while the first thru-hole 22 and the second thru-hole 32 are sized for retention. A grip channel 18 on the blade 10 is used for manipulating the blade 10 between retracted and deployed states. The grip channel 18 is accessed from a housing groove 28. The blade has a sharpened edge 17 having a smooth edge or a serrated edge or a combined edged with a smooth portion and a serrated portion.

A handcuff key 60 is disposed opposite the pin 15 location in a key recess 65 disposed between the first housing portion 20 and the second housing portion 30. A key flag 63 is oriented to a narrow axis of the personal safety tool 100.

A GPS tracker 50 is disposed internally in a first GPS recess 23 and a second GPS recess 33 situated on the first housing portion 20 and the second housing portion 30, receptively. The fist GPS recess includes a button or switch 24 activating the GPS tracker by pressing externally on the personal safety tool 100.

The first housing portion 20 is secured to the second housing portion 30 by a plurality of housing pins 31 fitting to a plurality of housing holes 21.

A glass breaking tool 70 is disposed externally on the tool housing, depicted on the second housing portion 30. The glass breaking tool 70 comes to a tip 75 concentrating energy to a fine point in order to break glass. A preferred embodiment of the glass breaking tool 70 is tungsten carbide.

In the present embodiment, the personal safety tool as illustrated shows recesses disposed equally in both the first and second tooling housing. In an additional embodiment, the recess is created in one of the housing portions, leaving the opposing portion flush, without a recess. In an alternate embodiment, the recess is disposed between both housing portions and biased to once side where the recess in not equal between the housing portions.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A personal safety tool, comprising:
a tool housing having a length and a width, the tool housing including a first housing portion and a second housing portion secured to the first housing portion, the tool housing including a longitudinal recess disposed between the first housing portion and the second housing portion;
a blade rotatably disposed in a blade cavity between the first housing portion and the second housing portion whereby the blade is rotatable from a closed position in the blade cavity to an open position wherein the blade extends outwardly from the tool housing, wherein the blade has a sharpened edge being exposed in the open position;
wherein the longitudinal recess allows the blade to be fully retained and concealed when in the blade is in the closed position;
a thru-pin disposed through an opening on a first end of the tool housing and through an opening on a blade end wherein the blade rotates about the thru-pin for deployment and retention of the blade;
a handcuff key disposed on a second end of the tool housing; and, a glass breaking tool extending outwardly from a portion of the tool housing, having a tip for impacting glass.

2. The personal safety tool according to claim 1 wherein the tip is tungsten carbide.

3. The personal safety tool of claim 1 wherein the sharpened edge includes a serrated edge.

4. The personal safety tool of claim 1 wherein the decorative element includes gold plating or silver plating or coloring.

5. The personal safety tool of claim 1 wherein the handcuff key is attached to a structure to form an appearance of a piece of jewelry.

6. The personal safety tool of claim 1 wherein the metal alloy is steel.

7. A personal safety tool, comprising:
a tool housing having a length and a width, the tool housing including a first housing portion and a second housing portion secured to the first housing portion, the tool housing including a longitudinal recess disposed between the first housing portion and the second housing portion;
a blade rotatably disposed in a blade cavity between the first housing portion and the second housing portion whereby the blade is rotatable from a closed position in the blade cavity to an open position wherein the blade extends outwardly from the tool housing, wherein the blade has a sharpened edge being exposed in the open position;
wherein the longitudinal recess allows the blade to be fully retained and concealed when in the blade is in the closed position;
a thru-pin disposed through an opening on a first end of the tool housing and through an opening on a blade end wherein the blade rotates about the thru-pin for deployment and retention of the blade;
a handcuff key disposed on a second end of the tool housing; and
a GPS tracking device disposed of internally in a portion of the tool housing.

8. The personal safety tool of claim 7 wherein a decorative element includes gold plating or silver plating or coloring.

9. The personal safety tool according to claim 7 wherein GPS tracking device is activated with a push button disposed on the tool housing.

10. The personal safety tool of claim 7 wherein the handcuff key is attaches to a structure to form an appearance of a piece of jewelry.

11. The personal safety tool of claim 7 wherein the sharpened edge includes a serrated edge.

12. The personal safety tool of claim 7 wherein the metal alloy is steel.

13. A personal safety tool, comprising:
a tool housing having a length and a width, the tool housing including a first housing portion and a second housing portion secured to the first housing portion, the tool housing including a longitudinal recess disposed between the first housing portion and the second housing portion;
a blade rotatably disposed in a blade cavity between the first housing portion and the second housing portion whereby the blade is rotatable from a closed position in the blade cavity to an open position wherein the blade extends outwardly from the tool housing, wherein the blade has a sharpened edge being exposed in the open position;
wherein the longitudinal recess allows the blade to be fully retained and concealed when in the blade is in the closed position;
a thru-pin disposed through an opening on a first end of the tool housing and through an opening on a blade end wherein the blade rotates about the thru-pin for deployment and retention of the blade;
a handcuff key disposed on a second end of the tool housing;
a glass breaking tool extending outwardly from a portion of the tool housing, having a tip for impacting glass; and,
a GPS tracking device disposed of internally in a portion of the tool.

14. The personal safety tool of claim 13 wherein a decorative element includes gold plating or silver plating or coloring.

15. The personal safety tool according to claim 13 wherein GPS tracking device is activated with a push button disposed on the tool housing.

16. The personal safety tool of claim 13 wherein the sharpened edge includes a serrated edge.

17. The personal safety tool of claim 13 wherein the handcuff key is attached to a structure to form an appearance of a piece of jewelry.

18. The personal safety tool according to claim 13 wherein the tip is tungsten carbide.

19. The personal safety tool of claim 13 wherein the metal alloy is steel.
